(19) United States
(12) Patent Application Publication
(10) Pub. No.: US 2012/0187318 A1
(43) Pub. Date: Jul. 26, 2012

(54) GAS VALVE WITH IMPROVING SAFETY STRUCTURE

(76) Inventor: Yu-Li CHEN, Taichung (TW)

(21) Appl. No.: 13/014,624

(22) Filed: Jan. 26, 2011

(51) Int. Cl. F16K 31/02

(52) U.S. Cl. 251/129.15

(57) ABSTRACT

A gas valve consists of a valve body. The valve body includes an inlet passage and a pilot passage. Said pilot connects to the inlet passage and a pilot ignition device set outside the valve body. Gas is led into said valve body through the inlet passage, passing said pilot passage, and is brought into the pilot ignition device. Said gas valve is characterized in that two solenoid valves are installed in the pilot passage. Said solenoid valves can open and shut the pilot passage, and when one of the solenoid valves function incorrectly, another valve will serve as an auxiliary, impeding the gas flow being delivered to the pilot ignition device, improving safety measure of the gas valve.

### FIELD OF THE INVENTION

The present invention relates to a structure of a gas ignition apparatus, more specifically, a gas valve.

### BACKGROUND OF THE INVENTION

A conventional gas valve 1, as illustrating in FIG. 1, comprises a valve body 2, a solenoid valve 3 and a shutting element 4. The valve body 2 has a an inlet and a pilot passage, gas is introduced into the inside of the valve body 2 through the inlet 5 and the pilot passage 6. The shutting element 4 is set in the pilot passage 6 and will be triggered by the solenoid valve 3 to open or close the pilot passage.

However, the valve fatigue or residue inside the valve body may cause the solenoid valve functioning abnormally, and once the pilot passage 6 can't be opened or shut properly, it affects the function of the gas valve, and the gas leaking may put the operator in a dangerous condition. Therefore, to provide a gas valve with better safety has become the primary objective of the present invention.

### SUMMARY OF THE INVENTION

To solve above identified defect, the present invention relates to a gas valve having two solenoid valves installed in the pilot passage, which can be realized by having a gas valve comprising a valve body and at least two solenoid valves. The valve body includes an inlet passage and a pilot passage. Said pilot connects to the inlet passage and a pilot ignition device set outside the valve body. Gas is led into said valve body through the inlet passage, passing said pilot passage, and is brought into the pilot ignition device. The two solenoid valves are disposed separately in the pilot passage by a predetermined distance. Said solenoid valves can open and shut the pilot passage, and when one of the solenoid valve opens incorrectly, another valve will remain shut, serving as an auxiliary to improve safety measure of the gas valve.

### BRIEF DESCRIPTION OF DRAWINGS

FIG. 1 is a cross sectional view of a conventional gas valve.

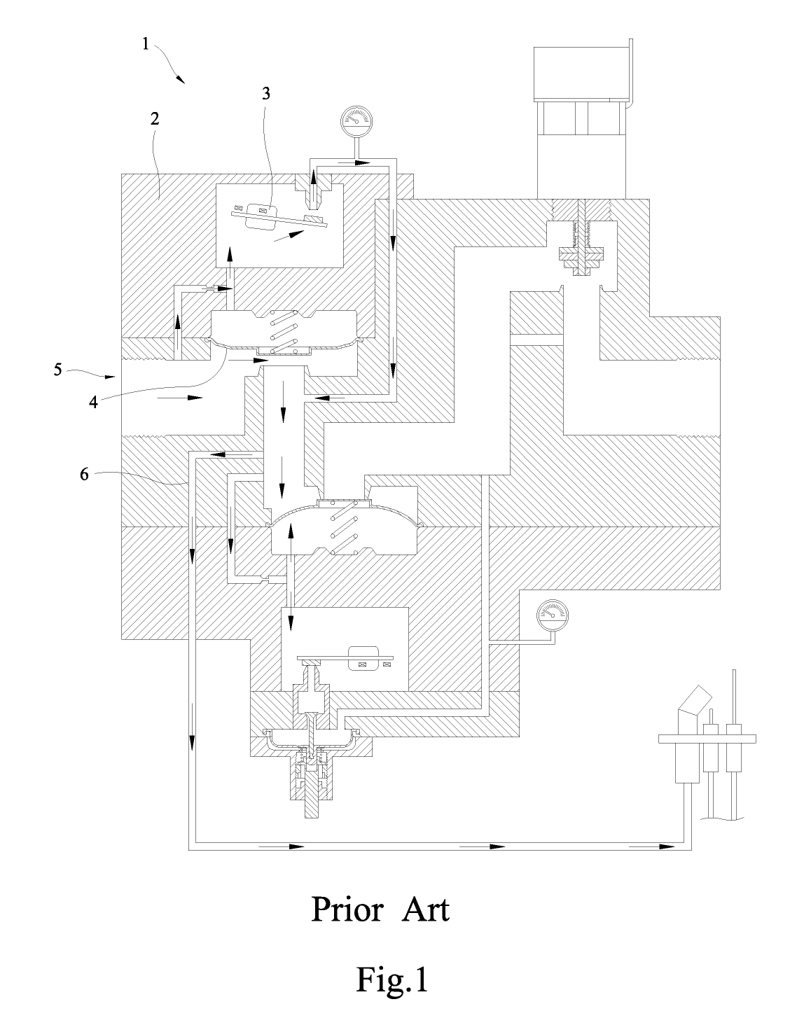

FIG. 2 is a perspective view of the gas valve of the present invention.

FIG. 3 is a cross sectional view of FIG. 2, showing a first and second solenoid valves opened in normal condition.

FIG. 4 is a cross sectional view of FIG. 2, showing the first and second solenoid valves closed in normal condition.

FIG. 5 is a cross sectional view of FIG. 2, showing the first solenoid valve opened in abnormal condition while second solenoid valve closed in normal condition.

FIG. 6 is a cross sectional view of FIG. 2, showing the first solenoid valve closed in normal condition while second solenoid valve opened closed in abnormal condition.

FIG. 7 is a cross sectional view of another embodiment of the present invention.

### DETAILED DESCRIPTION OF PREFERRED EMBODIMENTS

The preferred embodiments of the present invention are described in details hereinafter according to the appended drawings.

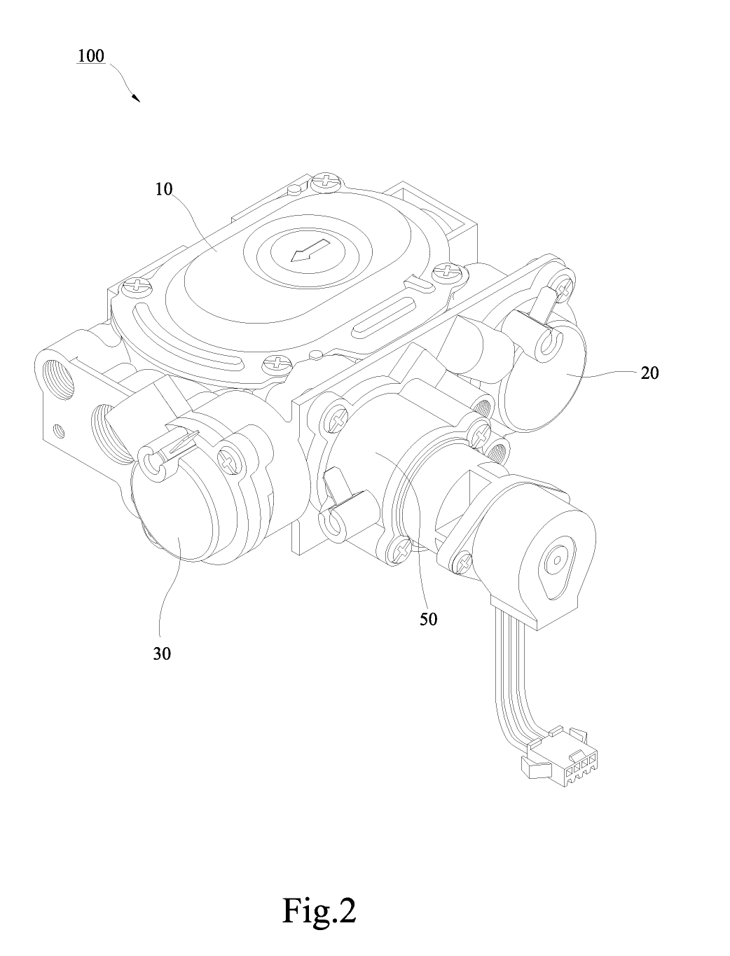

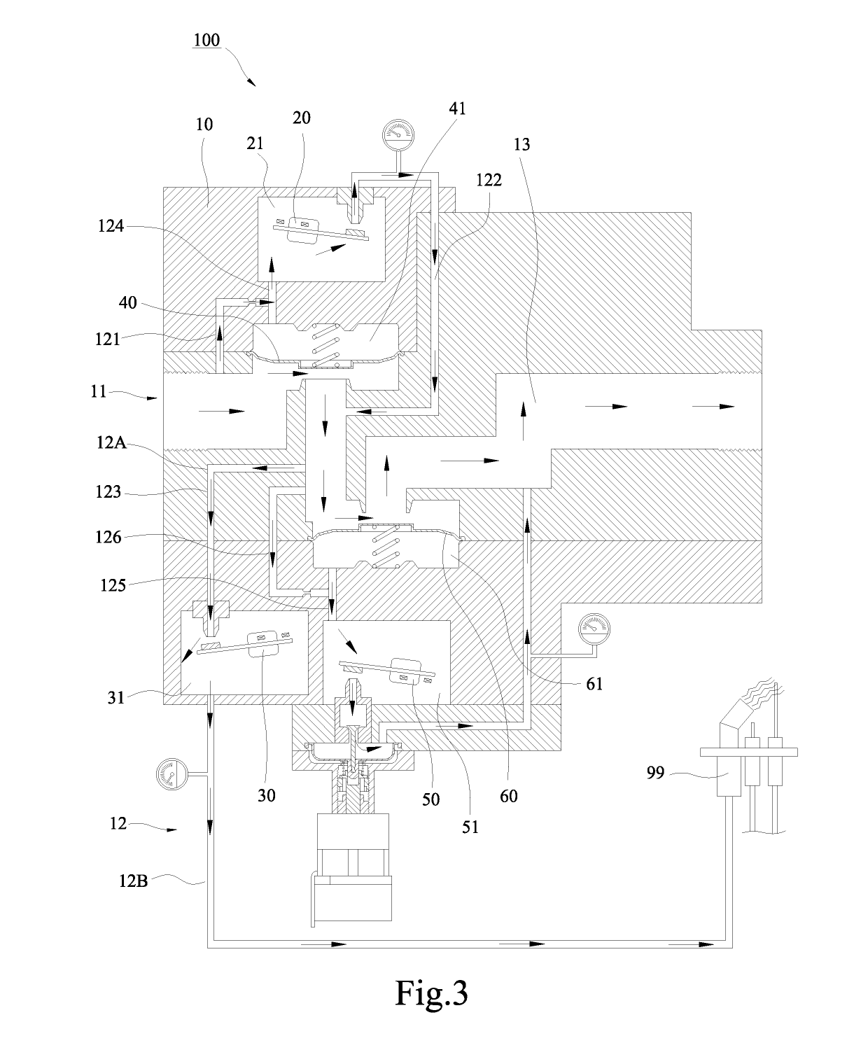

Referring to FIGS. 2˜6, a gas valve (100) comprising a valve body (10) and two solenoid valves (20, 30). According to FIGS. 2 and 3, said valve body (10) has an inlet passage (11) and a pilot passage (12). Said pilot passage (12) is divided in two sections, a first section which is an inner passage (12A) provided within the valve body (10) and joins the inlet passage (11); a second section which is an outer passage (12B) provided at outside of the valve body (10) and connects to a pilot ignition device (99). A gas is led into said valve body (10) through the inlet passage (11), passing said inner and outer passages (11, 12), and is brought into the pilot ignition device (99).

Said two solenoid valves can be a first and a second solenoid valve (20, 30); said first solenoid valve (20) is set in a first valve chamber (21), which is disposed in the inner passage (12A) of the valve body (10), while said second solenoid valve (30) is set in a second valve chamber (31), which is also disposed in the inner passage (12A) of the valve body (10). Both valves (20, 30) are disposed separately in the pilot passage by a predetermined distance.

FIG. 3 showing said first and second solenoid valves (20, 30) open the pilot passage (12) in a normal condition. When both solenoid valves (20, 30) open properly, gas flow can enter from the inlet passage (11) and is delivered to the pilot ignition device (99) for burning.

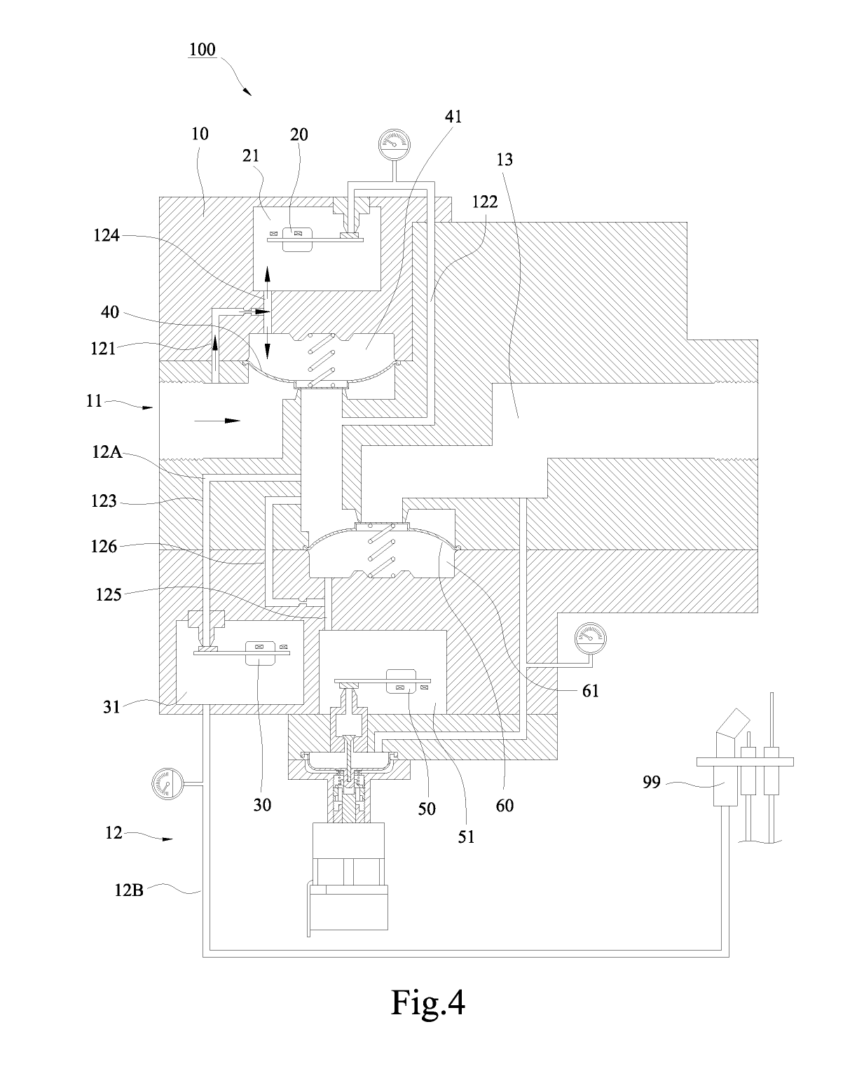

FIG. 4 showing said first and second solenoid valves (20, 30) close the pilot passage (12) in a normal condition. When both solenoid valves (20, 30) are shut properly, the gas flow is cut and can't be supplied to the pilot ignition device (99) through the inlet passage (11).

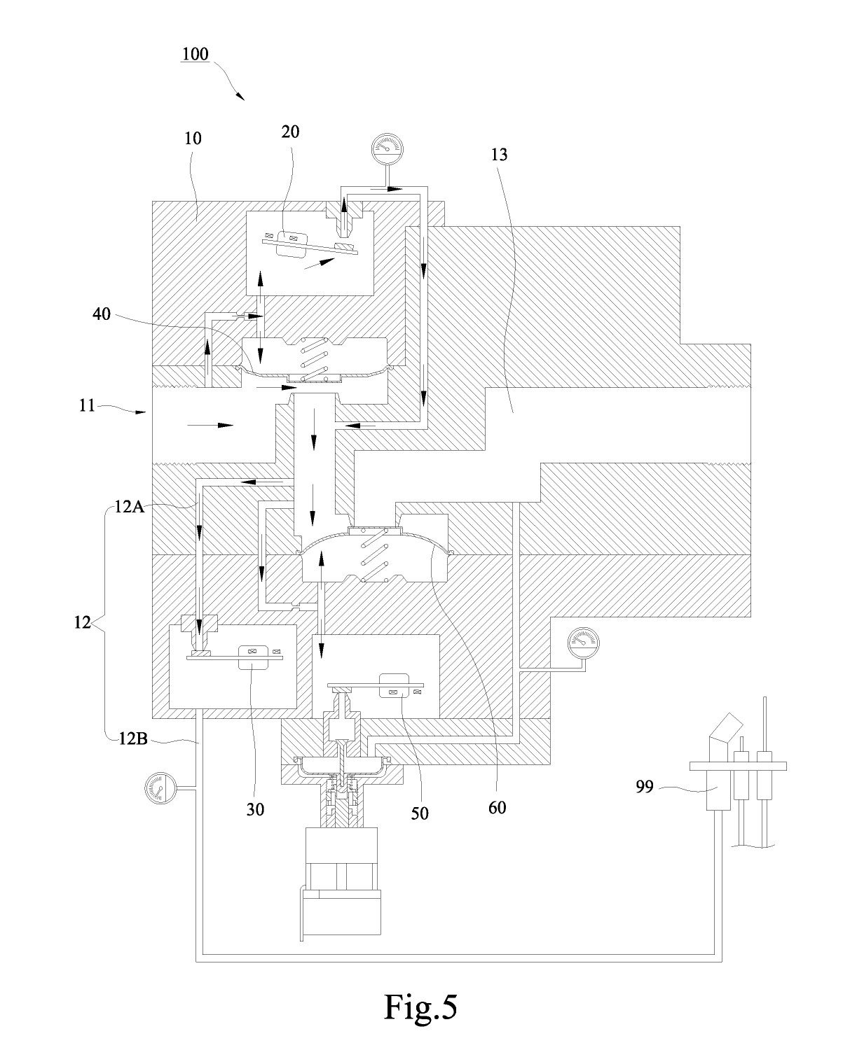

FIG. 5 showing when the first solenoid valve (20) fails to close, the second solenoid valve (30) may still close the pilot passage (12) to prevent the gas flow from entering the pilot ignition device (99), causing unnecessary waste and placing user in dangerous condition.

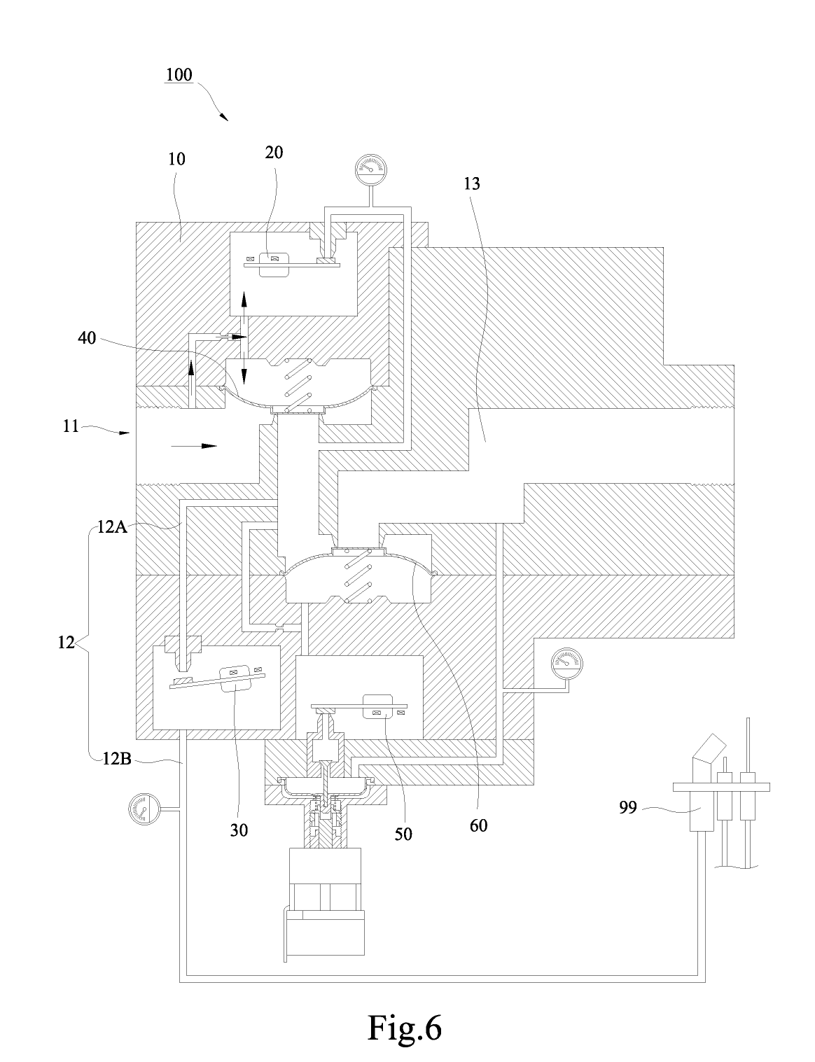

FIG. 6 showing a reverse situation as the second solenoid valve (30) fails to close, the first solenoid valve (20) will cut off the gas flow to avoid gas entering the pilot ignition device (99). The design of installation of two solenoid valves separately in the pilot passage (12) is when one of the solenoid valve functions incorrectly, another valve can still serve as auxiliary to protect the valve (100) and further improve the safety.

The gas valve (100) may further include a pilot shutting element (40), which is provided in a third valve chamber (41) of the valve body (10). Said third valve chamber (41) connects with the inlet passage (11) and also connects to the first valve chamber (21) by a first guide way (124). The first guide way (124) can connects to the inlet passage (11) through a first channel (121). The pilot shutting element (40) is triggered by the first solenoid valve (20) to be opened or shut synchronizingly. Thus, when the first solenoid valve (20) opens, the pilot shutting element (40) is also triggered to open, delivering gas flow to the pilot ignition device (99) passing the second solenoid valve (30); as the first solenoid valve (20) closes, it will trigger the shutting element (40) to cut the gas flow off.

A gas passage (13) can further be employed inside the valve body (10).

The gas passage (13) is connecting to the third valve chamber (41); said gas passage (13) connects to the first valve chamber (21) through a second channel (122) and connects to said second valve chamber (31) through a third channel (123). Said gas passage (13) can deliver gas to a burning unit (not shown).

The gas valve (100) further includes a gas solenoid valve (50) and a gas shutting element (60) are further provided; the gas solenoid valve (50) is set in a forth valve chamber (51) of the valve body (10), and the gas shutting element (60) is set in a fifth valve chamber (61) disposed in the gas passage (13). Both forth and fifth valve chambers (51, 61) are connecting through a second guide way (125) and the gas passage (13) is connecting to the second guide way (125) through a third guide way (126). The gas shutting element (60) is triggered by the gas solenoid vale (50) to be opened or shut synchronizingly. Thus, when the gas solenoid valve (50) closes, the gas shutting element (60) is also triggered to close the gas passage (13), cutting off the gas flow for avoiding the gas entering the pilot ignition device (99); and when the gas solenoid valve (50) opens, the gas shutting element (60) will be triggered to open the gas passage (13), delivering gas flow to said burning unit.

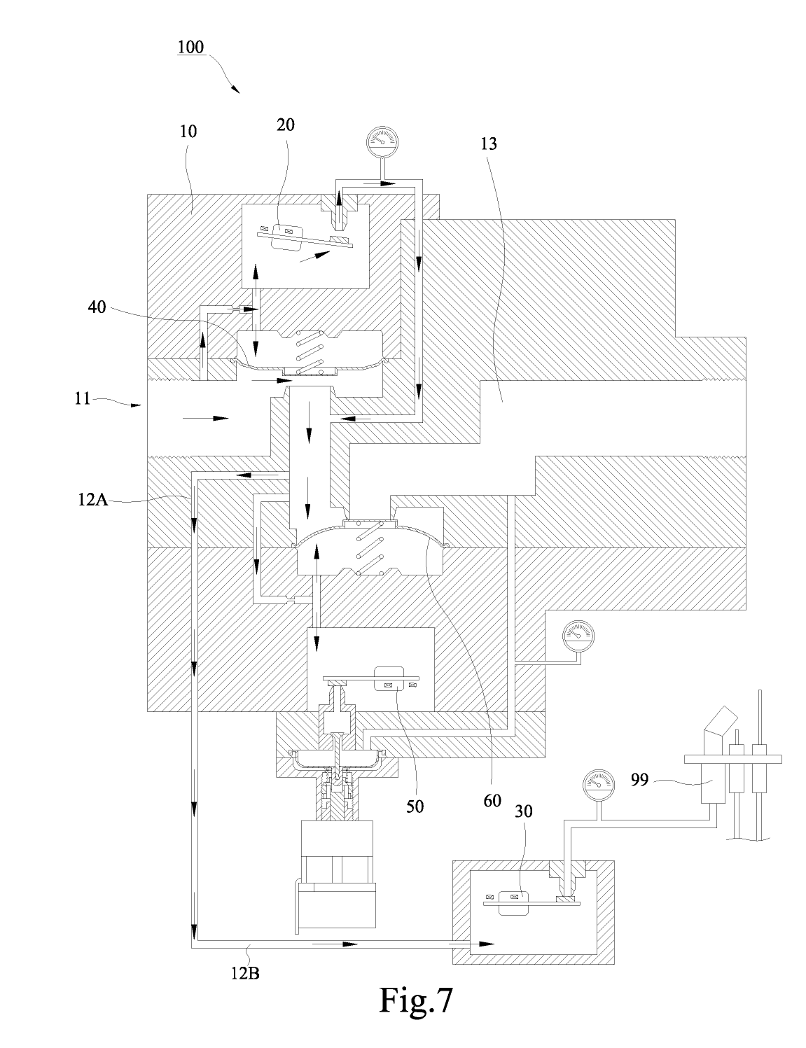

FIG. 7 illustrating a second embodiment of the gas valve (100). In the second embodiment, most structure is preserved but said second solenoid valve (30) is set in the outer passage (12B) outside of the valve body (10) instead of disposed in the second valve chamber (31) as mentioned in the previous embodiment.

1. A gas valve comprising a valve body, having an inlet passage and a pilot passage; said pilot passage is divided in two sections, a first section which is an inner passage provided within the valve body and joins the inlet passage, and a second section which is an outer passage provided at outside of the valve body and connects to a pilot ignition device; a gas is led into said valve body through the inlet passage, passing said inner and outer passages, is delivered to the pilot ignition device; wherein
At least two solenoid valves, a first and second solenoid valve are disposed separately in the pilot passage with a predetermined distance; said first solenoid valve is set in a first valve chamber, which is disposed in the inner passage of the valve body, while said second solenoid valve is set in a second valve chamber, which is also disposed in the inner passage of the valve body; said first and second solenoid valves open and shut the pilot passage, and when one of the solenoid valve opens incorrectly, another valve functions as auxiliary to shut the pilot passage, avoiding gas be led to the pilot ignition device.

2. The gas valve of claim 1, wherein said first solenoid valve is set in a first valve chamber disposed in the inner passage of the valve body; said second solenoid valve is set in a second valve chamber disposed in the inner passage of the valve body.

3. The gas valve of claim 2, wherein a pilot shutting element is further provided in a third valve chamber of the valve body; said third valve chamber connects with the inlet passage and also connects to the first chamber by a first guide way, and the first guide way connects to the inlet passage through a first channel; the pilot shutting element is triggered by the first solenoid valve to be opened or shut synchronizingly.

4. The gas valve of claim 3, wherein a gas passage is connecting to the third valve chamber; said gas passage connects to the first and second valve chamber through a second and third channel respectively; said gas passage provides gas to a burning unit.

5. The gas valve of claim 4, wherein a gas solenoid valve and a gas shutting element are further provided; the gas solenoid valve is set in a forth valve chamber, disposed in the valve body, and the gas shutting element is set in a fifth valve chamber, disposed in the gas passage; said forth and fifth valve chambers are connecting through a second guide way and the gas passage is connecting to the second guide way through a third guide way; the gas shutting element is triggered by the gas solenoid vale to be opened or shut synchronizingly.

6. The gas valve of claim 1, wherein said first solenoid valve is set in a first valve chamber disposed in the inner passage of the valve body; said second solenoid valve is set in the outer passage outside of the valve body.
